(19) United States
(12) Patent Application Publication
(10) Pub. No.: US 2005/0138372 A1
(43) Pub. Date: Jun. 23, 2005

(54) Information delivering system, information delivering apparatus, information delivering method and computer readable information recording medium

(76) Inventors: Masaru Kajihara, Osaka (JP); Kouji Fukao, Osaka (JP); Takayuki Kuramoto, Osaka (JP)

Correspondence Address: KATTEN MUCHIN ZAVIS ROSENMAN, 575 MADISON AVENUE, NEW YORK, NY, 10022-2585, US

(21) Appl. No.: 10/853,891

(22) Filed: May 25, 2004

(30) Foreign Application Priority Data
Dec. 22, 2003 (JP) 2003-424933

(51) Int. Cl. H04L 9/00

(52) U.S. Cl. 713/165

(57) ABSTRACT

A delivery apparatus ciphers main contents for each predetermined time interval, includes deciphering information for the predetermined time interval part of the main contents thus ciphered in CM contents and sending it out, and sends out the relevant predetermined time interval part of the main contents ciphered after sending out of the CM contents including the deciphering information.

### BACKGROUND OF THE INVENTION

1. Field of the Invention

The present invention relates to an information delivering system, an information delivering apparatus, an information delivering method and a computer readable information recording medium, and, in particular, to an information delivering system, an information delivering apparatus and an information delivering method providing a measure enabling predetermined information delivered to be received and used in a predetermined order.

2. Description of the Related Art

Recently, along with prevalence of a communication network, delivery of digital contents such as video, music or such for a receiving apparatus such as a personal computer, a set-top box, or such via an IP network has been widely performed. In such an information delivering system, a service providing contents having high popularity with some charge, a service providing contents together with a commercial video or such by a sponsor free of charge (for example, a streaming advertisement video delivery service such as PaSaTa) or such may be provided.

As a specific method applicable for such a digital content delivery system with the use of an IP network, for example, a method of delivering a large size of data in real time with RTP packets carrying content data according to an RTP (real time protocol: rfc1889) prepared for transmitting content data in real time and RTCP (RTP control protocol) packets for controlling transmission of the RTC packets is generally known.

There are two methods of such a delivery service, i.e., a method of service (on-demand service) in which digital contents which are previously prepared and stored for a predetermined delivery form is delivered from the top of the contents in response to a particular user's request; and a method of service (broadcast service) in which predetermined contents are delivered to many destinations at once according to a predetermined scheduled program (timetable).

In the above-mentioned on-demand service, it is necessary to deliver content data in respective forms according to respective operation requests (i.e., start of reproduction, pause, fast-forward reproduction, rewind, or such) given by a viewer (user). Then, in order to achieve such a system, it is necessary to prepare a delivery server performance, a repeater server performance, a delivery network band, and so forth for each of the respective operations requests for a particular viewer, for each of a required number of delivery items. Accordingly, in this method, a very large delivery capacity may be needed for achieving a large-sized devilry system providing contents for many viewers.

On the other hand, in the above-mentioned broadcast service, common contents are delivered to many viewers for each event uniformly according to a predetermined timetable, and thus, in comparison to the case of the above-mentioned on-demand service, it is possible to achieve a large-sized delivery system even with a well reduced capacity required to be prepared.

On the other hand, in the above-mentioned delivery service in which a commercial message or such by a sponsor is inserted in the contents, it is important that the commercial message or such should be viewed by many viewers positively. In order to achieve this object, for example, the following two methods may be conceived, i.e.: 1) a first method in which a commercial message or such is delivered first, and after that, the main contents are delivered; and 2) a second method in which main contents are ciphered, information needed for deciphering it is included in commercial-message contents, and thus, the complete set of the main contents can be viewed only after delivery (reproduction) of the commercial-message contents (see Japanese Laid-open Patent Application No. 2002-51321).

### SUMMARY OF THE INVENTION

The following problems may occur when employing the above-mentioned methods 1) and 2) to achieve the object of positively causing a viewer to view predetermined information such as a commercial message by a sponsor.

First, with regard to the first method 1), it is difficult to apply this method to the above-mentioned broadcast service suitable for achieving large-size delivery. That is, in such a system, generally, a viewer knows delivery programs previously, and thus, the viewer may intentionally avoid reception of only the predetermined information such as a commercial message. In this view, the first method 1) may only be applicable for the above-mentioned on-demand service which is not suitable for a large-sized delivery system as mentioned above, and thus, this method is not suitable for a large-sized delivery system.

Furthermore, according to the first method 1), it is necessary to insert the predetermined information such as a commercial message at the top of the main contents. Otherwise, of the predetermined information is inserted at the tail of the main contents, a viewer may stop reception of the predetermined information such as a commercial message intentionally after viewing the main contents. However, assuming that the position of insertion of the predetermined information such as a commercial message is fixed at the top of the main contents as mentioned above, in case where the size of the main contents is very large (i.e., a case of long hours of contents or such), a problem may occur. That is, although, generally speaking, in such a case, a sponsor wishes to provide the predetermined information such as a commercial message having a long size according to the long size of the main contents accordingly, such a wish may not be achieved since a viewer may not endure to view a long time of the predetermined such as a commercial message at one go before viewing the main contents even though the main contents are those for long hours.

With regard to the above-mentioned second method 2), this method may be applied for the above-mentioned broadcast service. Specifically, as disclosed in the above-mentioned Japanese Laid-open Patent Application No. 2002-51321, ‘Digital Video Transmitter, Digital Video Receiver, and Digital Video Transmitter/Receiver’, decoding information which is information needed for deciphering is included in a PES packet which is an element of an MPEG-TS stream. However, in this system, it is needed to previously prepare contents in a form of an MPEG-TS with the use of a multiplexer or such. In other words, during this preparation stage, a manner of combination between a part of the contents which is ciphered and another part thereof which is not ciphered is fixed.

However, in a service of delivering contents together with a commercial message or such, in which a sponsor wishes the commercial-message contents to be viewed by each viewer then positively functioning, an area for which the delivery is made, a time at which the delivery is made, or such, may be important factors for determining specific contents of the commercial message to be inserted, in general. Especially, in case of delivery via the Internet, it is possible to specify viewers, and in such a case, it is effective to switch the commercial-message contents according to each particular group of target viewers flexibly. In order to achieve this object, a flexible delivery system is preferable in which also switching a mode as to whether or not the contents to be delivered are ciphered can be performed in real time.

Furthermore, in consideration to an expectable situation in which a service of delivering contents together with a commercial message or such will be further wide spread in future, it is preferable to provide a system in which currently delivering contents can be switched into predetermined emergency public contents upon occurrence of a disaster or such even during delivery of a ciphered part of the contents.

That is, a delivery system of appropriately satisfying a possible demand to switch the contents of the predetermined information such as a commercial message even immediately before the delivery thereof, a position or a length of insertion of the predetermined information such as a commercial message along time axis or temporally is not fixed during a time of preparing the main contents, and also, interruption of ciphering can be rapidly performed upon occurrence of a situation in which emergency broadcast or such is needed is preferable.

In order to achieve this object, according to the present invention, for delivering predetermined first information and predetermined second information from a delivering station to a receiving terminal, each predetermined time interval of the second information (i.e., the main contents or such) is ciphered; and deciphering information needed for the predetermined time interval part of the second information thus ciphered is included in the first information (i.e., the predetermined information such as a commercial message) and then is sent out. After that, the relevant predetermined time interval part of the second information ciphered is sent out after the first information including the deciphering information is sent out.

As a result, in a receiving apparatus, the first information including the deciphering information for the predetermined interval part of the second information is received, and therefrom, the deciphering information is obtained. Then, with the use of the thus-obtained deciphering information, the predetermined interval part of the second information received after that is deciphered, and is provided to a user in a visible and audible data form on a display device or such. As a result, after receiving and viewing the first information such as a commercial message including the deciphering information, a viewer (user) can view the main contents in the second information after it is deciphered with the use of the deciphering information included in the first information. This operation process is repeated for each of subsequent predetermined time interval parts of the second information delivered in time-series manner, in sequence. That is, the viewer cannot avoid receiving and viewing of the first information such as a commercial message even if the viewer does not necessarily wish it in order to decipher the main contents, upon receiving each successive part of the main contents.

Thus, according to the present invention, the second information such as main contents are first divided for respective predetermined time intervals along time axis or temporally, each part thus obtained from the division along time axis is ciphered part by part, then, at each time, deciphering information needed for deciphering it is included in the first information such as a commercial message which a sponsor or such wishes a viewer to positively view and is sent out first. After that, the thus-ciphered part of the second information is sent out. In this system, since a process of including deciphering information in the first information such as a commercial message can be performed substantially immediately before delivery of the second information such as the main contents, it is possible to switch the contents of the first information such as a commercial message immediately before the delivery of the second information.

Furthermore, according to the present invention, the second information such as the main contents is divided along time axis, each division thereof is ciphered, and deciphering information is included in the first information such as a commercial message for each ciphering process and is sent out as mentioned above. Thereby, even in a case where the second information such as the main contents is one for long hours, for example, this is divided into divisions, each of which is one for short interval accordingly, and then, the first information such as a commercial message can be inserted for each division, by which a view can endure to view the commercial message or such before viewing the main contents since each commercial message inserted is short as mentioned above. Accordingly, since a company which operates a content delivery system can insert a commercial message or such each predetermined interval during delivery of main contents, it is not necessary to elongate a insertion time of a commercial message each time. That is, by inserting a short time of commercial message or such repetitively for each division of the main contents, it is possible to achieve the object of causing a viewer to view a totally long time of commercial message finally. At the same time, the viewer should not endure viewing a commercial message for a long time at one go at the top of the main contents even if the viewer does not wish it, and thus can view the delivered contents in an endurable situation.

Furthermore, since ciphering is performed for each of predetermined time interval parts of the second information such as the main contents, it is possible to interrupt it shortly even when a predetermined situation occurs in which emergency broadcast is required. Accordingly, it is possible to build a delivery system which can flexibly respond to various situations.

### BRIEF DESCRIPTION OF THE DRAWINGS

Other objects and further features of the present invention will become more apparent from the following detailed description when read in conjunction with the accompanying drawings:

FIG. 1 shows a configuration of digital content delivery system in one embodiment of the present invention;

FIG. 2 shows a block diagram of a digital content ciphering apparatus shown in FIG. 1;

FIGS. 3 and 4 show an operation flow chart of operation of the digital content ciphering apparatus shown in FIG. 2;

FIG. 5 shows an operation flow chart of operation of a content reading part shown in FIG. 1;

FIG. 6 shows an operation flow chart of operation of a delivery processing part shown in FIG. 1;

FIG. 7 shows a block diagram of a ciphered digital content receiving apparatus shown in FIG. 1;

FIG. 8 shows an operation flow chart of operation of a ciphered digital content receiving apparatus shown in FIG. 1;

FIG. 9 shows a time chart illustrating a digital content delivery process and a process in the receiving apparatus in this response according to the embodiment of the present invention, and illustrating in a time-series manner a state in which ciphered RTP packets, non-ciphered RTP packets, RTCP packets carrying ciphering information are transmitted;

FIG. 10 shows a data format of an application dependent area in an APP-RTCP packet carrying ciphering key information applicable in the delivering operation shown in FIG. 9;

FIG. 11 shows a time chart illustrating a digital content delivery process and a process in the receiving apparatus in this response according to the embodiment of the present invention, and illustrating in a time-series manner a state in which a ciphering interruption notice RTCP packet is transmitted while ciphered RTP packets, non-ciphered RTP packets, RTCP packets carrying ciphering interruption notice are transmitted; and

FIG. 12 shows a data format of an application dependent area in an APP-RTCP packet carrying ciphering interruption information applicable in the delivering operation shown in FIG. 11.

### DESCRIPTION OF THE PREFERRED EMBODIMENT

According to an embodiment of the present invention, information delivered in form of RTP packets such as those mentioned above is divided along time axis or temporally, the thus-obtained each division is ciphered, and the thus-ciphered contents are deciphered in an apparatus on a part of a viewer (user). In order to transmit deciphering information needed to decipher the ciphered information delivered, an RTCP packet such as that mentioned above is used. That is, previously, with the use of an RTCP packet, a ciphering scope (ciphering start time and ciphering end time) information and deciphering information are transmitted to the viewer.

Further, a payload part of an RTP packet for delivering main contents is ciphered in real time. Then, during a time of RTP delivery of commercial message or such, deciphering information for ciphered main contents, to be transmitted subsequently, is transmitted in a state of being dispersed along time axis with the use of RTCP packets. By this scheme, the apparatus on the viewer's part can collect RTCP packets including the deciphering information only by receiving the commercial message or such and thus viewing the same accordingly. This measure of causing a commercial message or such to be positively viewed is described next.

That is, a digital content delivery system is provided which includes a digital content delivery server which delivers or repeats digital contents; and a digital content ciphering apparatus operating in cooperation with the digital content delivery server and ciphering a predetermined interval part of digital contents which the digital content delivery server then delivers.

The above-mentioned digital content delivery server has a function of responding to instructions given by an operator directly, or from the digital content ciphering apparatus in cooperation therewith, for selecting a predetermined one of a given plurality of sorts of contents, and delivering it. The digital content delivery server also has a function of responding to instructions from the digital content ciphering apparatus for not ciphering, or responding to instructions to switch the contents to be delivered into CM (commercial message) contents or such.

The digital content ciphering apparatus has a function of sending instructions to the digital content delivery server to cause the server to notify a ciphered digital content receiving apparatus (on the viewer's part) of deciphering information for the contents to be delivered, previously. The embodiment of the present invention also includes the ciphered digital content receiving apparatus having a function of receiving the digital contents delivered from the digital content delivery system as well as the content deciphering information, deciphering the ciphered digital contents delivered so as to convert the delivered digital contents into those in a visible and audible state for a viewer/user.

Furthermore, the digital content ciphering apparatus has a function of responding to real-time operation made thereto, for immediately interrupting ciphering of given digital contents, and also, giving instructions to the digital content delivery server for causing the server to notify the ciphered digital content receiving apparatus of this ciphering interruption event. By this function, the digital content ciphering apparatus can switch the delivery mode from ciphered digital content delivery mode into non-ciphered digital content delivery mode at any time.

Furthermore, the digital content ciphering apparatus has a scheduling function, and thus has a function of automatically ciphering a predetermined time interval part of the contents to be delivered at a time of actually delivering it, giving instructions to the digital content delivery server to cause the server to deliver it, and, before actual delivery of the thus-ciphered part of the contents, to deliver content deciphering information in a manner of being dispersed along time axis or temporally.

That is, according to the embodiment of the present invention, when digital content delivery is performed, main content information carried by an RTP payload is ciphered, and, deciphering information therefor is previously transmitted in a dispersed along time axis with the use of RTCP packets along with delivery of CM (commercial message) contents or such. By this function, a viewer on a receiving part can view the main contents only after viewing the CM contents.

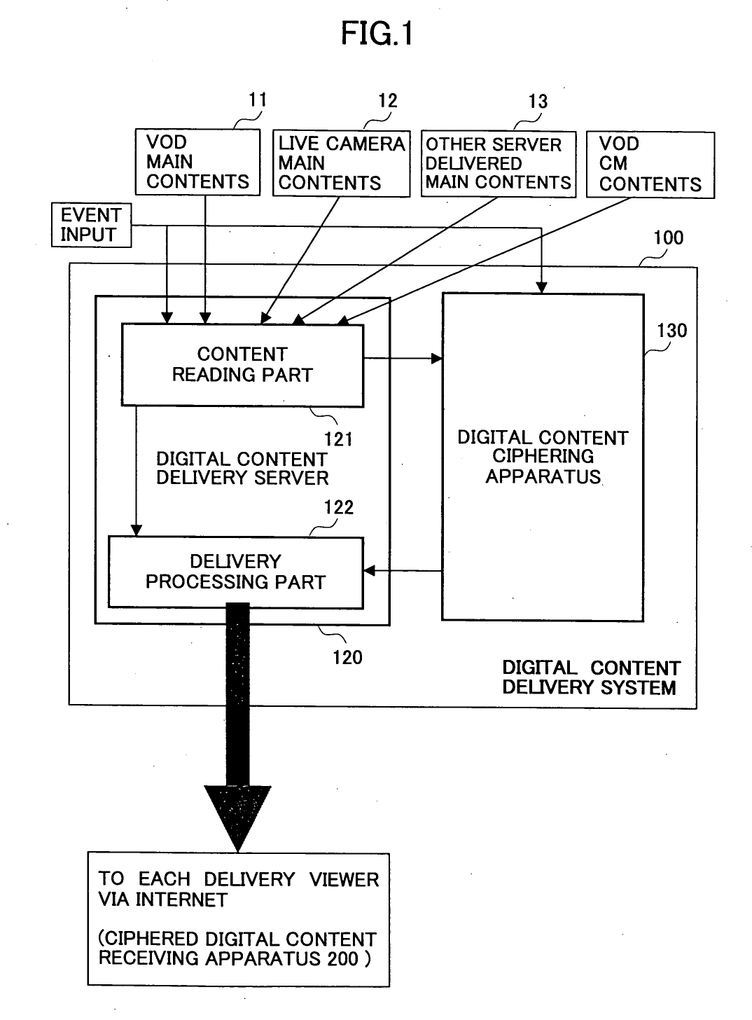

In order to achieve this scheme, in the embodiment of the present invention, as shown in FIG. 1, the digital content deliver system 100 is provided including the digital content delivery server 120 which delivers or repeats digital contents and the digital content ciphering apparatus 130. By this configuration, the contents to be delivered are ciphered with the use of ciphering (key) information, which contents are then delivered, simultaneously ciphering information (served as deciphering information) is transmitted with the use of RTCP packets. The ciphered digital content receiving apparatus 200 receives the thus-transmitted ciphered contents as well as the deciphering information, deciphers the ciphered contents with the use of the deciphering information, and thus, converts the ciphered contents into those in a state visible and audible for the viewer.

Thus, the embodiment of the present invention includes the digital content delivery system 100 including the digital content delivery server 120 which delivers or repeats the contents, and the digital content ciphering apparatus 130 which cooperates with the digital content delivery server 120, ciphers each part of digital contents which the server 120 delivers, which part ciphered is a part having a fixed time interval, and also, gives the server 120 instructions to cause the server 120 to notify the ciphered digital content receiving apparatus 200 of the relevant content deciphering information previously.

Further, the embodiment of the present invention includes the ciphered digital content receiving apparatus 200 which receives the digital contents and the content deciphering information delivered from the digital content delivery system 100 as described above, deciphers the ciphered contents thus received so as to convert them into those in a visible and audible form.

Furthermore, the digital content ciphering apparatus 130 responds to real-time instructions given thereto, for immediately interrupting ciphering of the digital contents, and then, gives instructions to the digital content deliver server 120 to cause the server 120 to notify the ciphered digital content receiving apparatus 200 of this event of interruption of ciphering operation. As a result, it is possible to switch, at any time, a ciphered digital content delivery mode into a non-ciphered digital content delivery mode.

Furthermore, the digital content ciphering apparatus 130 has a schedule function, as mentioned above, whereby a predetermined time interval part of the contents to be delivered is ciphered automatically according to a predetermined schedule, and then, upon delivering the thus-obtained ciphered digital contents, instructions are given to the digital content delivery server 120 to deliver content deciphering information needed for deciphering the ciphered digital contents before delivering the relevant ciphered digital contents themselves, in a manner of being dispersing along time axis or in a time-series manner.

Each apparatus included in the embodiment of the present invention is described next in detail.

As shown in FIG. 1, the digital content delivery server 120 includes a content reading part 121 and a delivery processing part 122. The digital content ciphering apparatus 130 receives RTP packets before delivery from the content reading part 121 of the digital content delivery server 120, and transfers them to the delivery processing part 122 of the digital content delivery server 120. During the process, the digital content ciphering apparatus 130 reads a time stamp value set in a time stamp part of the RTP packet, and regards this value as current time information. However, when predetermined ciphering instructions are not previously given to the digital content ciphering apparatus 130, the digital content ciphering apparatus 130 performs no operation on the RTP packet other than the above-mentioned reading out of the time stamp value.

The delivery processing part 122 in the digital content delivery server 120 delivers externally an RTP packet transferred from the digital content ciphering apparatus 130 whether the RTP packet given is a ciphered RTP packet or a non-ciphered one. Further, when an RTCP packet is transferred from the digital content ciphering apparatus 130, the delivery processing part 122 transmits the packet to a delivery viewer (i.e., the ciphered digital content receiving apparatus 200).

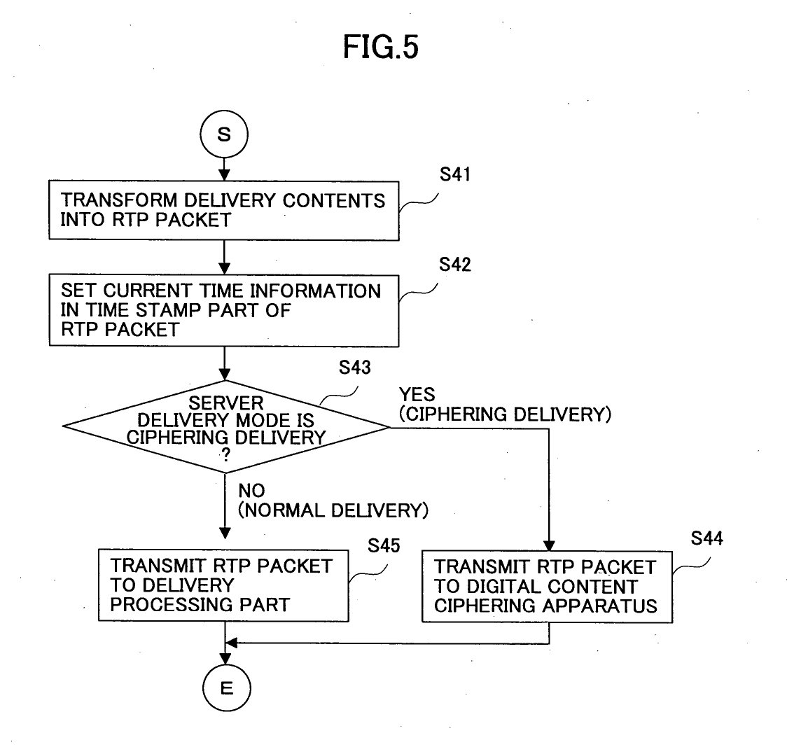

Switching of delivery contents from among various sorts of contents including main contents 11, 12, 13 and CM contents 14 is performed by the content reading part 121 of the digital content delivery server 120. That is, the content reading part 121 converts original medium data (live video data, MPEG2-TS data, analog data or such) obtained from among the various data sources, i.e., a VOD main contents 11, a live video camera main contents 12, another server delivered main contents 13, a VOD CM contents 14, and so forth, into RTP packets, sets current time information in a time stamp part of each RTP packet, and transfers the respective RTP packets to th digital content ciphering apparatus 130. However, as will be described later with reference to FIG. 5, it is possible to provide a configuration whereby the content reading part 121 determines whether or not each RTP packet should be ciphered, and, when it is determined that ciphering should not be performed, the relevant RTP packet is not transferred to the ciphering apparatus 130 but is directly transferred to the delivery processing part 122.

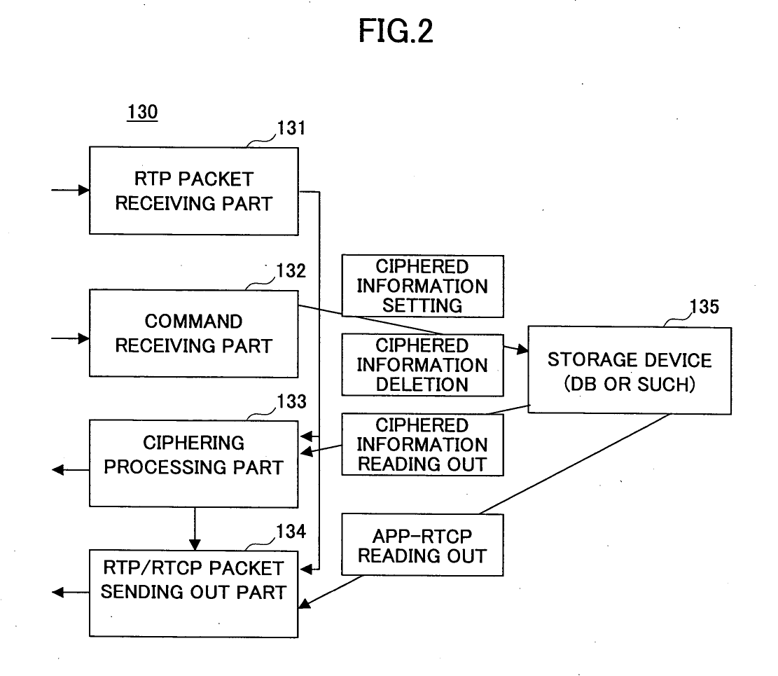

FIG. 2 shows a block diagram of the digital content ciphering apparatus 130. As shown, the digital content ciphering apparatus 130 includes an RTP packet receiving part 131, a command receiving part 132, a ciphering processing part 133, an RTP/RTCP packet sending out part 134 and a storage device 135. The RTP packet receiving part 131 receives contents which is read out from the above-mentioned data source and converted into an RTC packet by the content reading part 121, and transfers it to the ciphering processing part 133 or the RTP/RTCP packet sending out part 134. The command receiving part 132 receives ciphering information input to the digital content delivery server 120 from an external host computer or such, not shown, and writes it in the storage device 135.

The ciphering processing part 133 appropriately reads out the ciphering information received via the command receiving part 132 and written in the storage device 135 therefrom, compares it with the time stamp value of an RTP packet received by the RTP packet receiving part 131, ciphers the RTP packet when this time stamp value lies within a time interval defined between a ciphering start time and a ciphering end time included in the thus-read-out ciphering information, and then, sends out the thus-ciphered RTP packet to the delivery processing part 122 in the digital content delivery server 120 via the RTP/RTCP packet sending out part 134. The RTP packet having any other time stamp value is not ciphered thereby, and then, is directly sent out to the delivery processing part 122 in the digital content delivery server 120 via the RTP/RTCP packet sending out part 134.

The above-mentioned operation is described next in detail. The content reading part 121 in the digital content delivery server 120 sets, in the digital content ciphering apparatus 130, ciphering information such as RTP ciphering start time, RTP ciphering end time, ciphering key information, ciphering information notice start time, ciphering information notice end time and so forth. This information is actually written in the storage device 135 via the command receiving part 132, as mentioned above. In case where a configuration is provided in which the contents to be delivered are determined according to given instructions indicating whether or not the contents to be delivered currently are ciphered, the content reading part 121 in the digital content delivery server 120 is appropriately notified of the RTP ciphering start time and the RTP ciphering end time from the digital content ciphering apparatus 130. Specifically, for example, as mentioned above, instructions of not ciphering is sent to the content reading part 121 from the ciphering apparatus 130 at a time for which it is previously determined that ciphering is not performed. As a result, the content reading part 121 reads out the CM contents from the relevant data source, and are delivered via the delivery processing part 122 without being ciphered, for example.

The command receiving part 132 in the digital content ciphering part 130 calculates a dividing number for ciphering key information, from a time interval defined between the predetermined ciphering information notice start time and ciphering information notice end time set as mentioned above. The dividing number means the number by which the ciphering key information (i.e., substantially, corresponding to deciphering information) is divided to be delivered in the manner of being dispersed along time axis or temporally as mentioned above. Then, according to the thus-obtained calculation result, a single fragment of the ciphering key information needed for deciphering a part of main contents to be delivered, which part is a part of the main contents for a time interval defined between the relevant ciphering start time and ciphering end time is divided into a plurality of divisions, i.e., a plurality of fragments. Then, each of the thus-obtained fragments of the ciphering key information are carried by an application independent data area of an APP (application dependent RTP packet)-RTCP packet, and then is sent out to the delivery processing part 122 of the digital content delivery server 120.

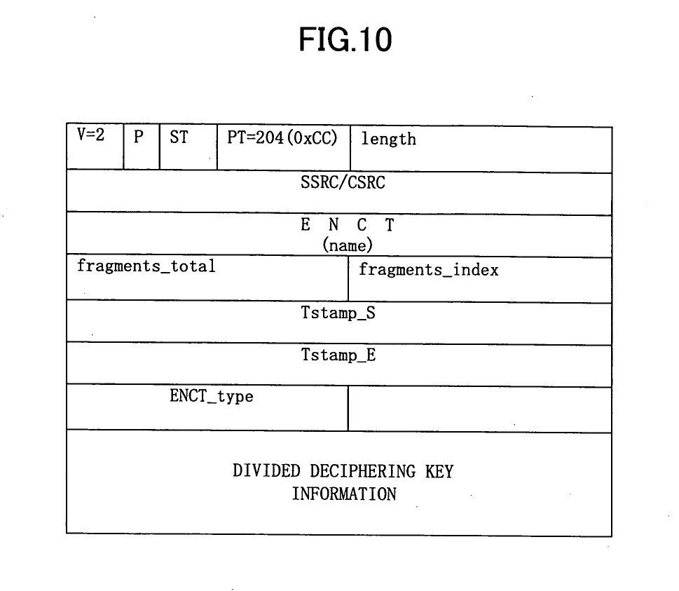

The application dependent data area in the APP-RTCP packet is a data area having a 32-bit unit length which can be freely used by a particular application, and an example of how to apply it is shown in FIG. 10. FIG. 10 illustrates an example of data format in case where the above-mentioned ciphering key information fragment is transmitted, with the use of the application dependent data area of the APP-RTCP packet.

In FIG. 10, in an area of ‘ENCT’, a value indicating a name of this APP-RTCP packet as ‘ciphering information notice’ is set; a value indicating the total number of the ciphering key information fragments, i.e., the above-mentioned dividing number is set in an area of ‘fragments_total’; a value indicating the order number of the particular fragment from among all the ciphering key information fragments is set in an area of ‘fragment_index’; the ciphering start RTP time stamp value is set in an area of ‘Tstamp_S’; the ciphering end RTP time stamp value is set in an area of ‘Tstamp_E’; a ciphering method identification value is set in an area of ‘ENCT_type’; and data unique to the ciphering method is set in an area of ‘DIVIDED DECIPHERING KEY INFORMATION’ (corresponding to the above-mentioned ciphering key information fragment).

Further, the command receiving part 132 in the digital content ciphering apparatus 130 calculates an optimum APP-RTCP packet sending out time interval from information indicating the above-mentioned time interval between the ciphering information notice start time and the ciphering information notice end time, and information of the number of APP-RTCP packets carrying the relevant ciphering key information. Then, upon detecting an RTP packet having the ciphering information notice start time, the RTP/RTCP packet sending out part 134 transfers the APP-RTCP packet at each optimum APP-RTCP packet sending out time interval thus calculated, to the digital content delivery server 120.

The digital content delivery server 120 sends out, to the viewer (i.e., the ciphered digital content receiving apparatus 200), the APP-RTCP packet thus transferred from the digital content ciphering apparatus 130. The ciphered digital content receiving apparatus 200, receiving thus-transmitted APP-RTCP packets, stores the thus-received APP-RTCP packets, combines the above-mentioned ciphering key information fragments obtained therefrom so as to obtain the single complete set of the ciphering key information.

After receiving the RTP packet having a time stamp value coincident with the RTP ciphering start time set in the storage device 135 in the digital content ciphering apparatus 130 as mentioned above via the RTP packet receiving part 131 from the content reading part 121 in the digital content delivery server 120, the ciphering processing part 133 in the digital content ciphering apparatus 130 ciphers the RTP payload part thereof according to the ciphering key information previously set as mentioned above, and transfers the ciphered one to the delivery processing part 122 in the digital content delivery server 120 via the RTP/RTCP packet sending out part 134.

This operation of ciphering the RTP payload part by the ciphering processing part 133 is repeated in sequence one by one for the RTP packets received from the content reading part 121 in the digital content delivery server 120, until the RTP packet having a time stamp value coincident with the RTP ciphering end time previously set as mentioned above is received from the content reading part 121 in the digital content delivery server 120. In this case, the digital content ciphering apparatus 130 does not especially pay attention to whether the payload part of the RTP packet received from the content reading part 121 of the digital content delivery server 120 has the main contents or the CM contents, but determines, only from the time stamp value of the relevant RTP packet, whether ciphering should be performed thereon, as described above.

When receiving from the digital content delivery server 120 the RTP packet having the time stamp value coincident with the RTP ciphering end time previously set in the apparatus 130 as mentioned above, during the above-mentioned ciphering operation, the digital content ciphering apparatus 130 performs ciphering on the payload part of this RTP packet, but does not perform ciphering on the payload part of any other RTP packet having a time stamp value later than that.

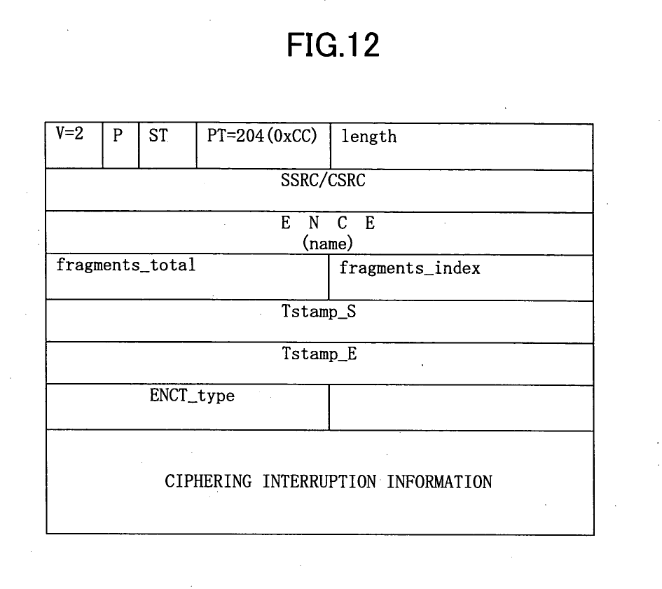

Further, when an operator forcibly interrupts this operation of ciphering the payload part of each given RTP packet, through direct operation performed by him or her on the apparatus 130 during the ciphering operation, the digital content ciphering apparatus 130 sets this ciphering interruption event as ‘ciphering interruption information’ in the application dependent data area of the APP-RTCP packet to be used for ciphering interruption notification as shown in FIG. 12. Then, the digital content ciphering apparatus 130 transfers this APP-RTCP packet to the delivery processing part 122 in the digital content delivery server 120. The delivery processing part 122 receiving the APP-RTCP packet transmits it to the viewer (i.e., the ciphered digital content receiving apparatus 200).

In FIG. 12, in the area of ‘ENCT’, a value indicating a name of this APP-RTCP packet as ‘ciphering interruption notice’ is set; ‘0’ is set in the area of ‘fragments_total’; also ‘0’ is set in the area of ‘fragment_index’; an RTP time stamp value indicating ciphering interruption designated time is set in the area of ‘Tstamp_S’; ‘0’ is set in the area of ‘Tstamp_E’; ciphering interruption identification value is set in the area of ‘ENCT_type’; and a cause of the relevant interruption or such is set in the area of ‘CIPHERING INTERRUPTION INFORMATION’.

The above-mentioned ciphering operation and non-ciphering operation are repeated alternatively for an arbitrary time interval. It is possible that the ciphering information applied may be altered each time of switching between the ciphering operation and the non-ciphering operation. Furthermore, timing for performing transmission of the deciphering information in a manner of dividing into fragments (dispersed transmission) with the use of the APP-RTCP packets mentioned above is not limited to timing of delivery of non-ciphered RTP packets. That is, for example, it is possible to insert deciphering information needed to decipher the last five minutes of a predetermined program, in the first five minutes of the same program during the delivery thereof. Thereby, if a viewer does not receive, and thus, does not view the first five minutes of the program, the viewer cannot view the last five minutes of the program since the relevant deciphering information cannot be obtained.

The above-described operation in the embodiment of the present invention is described next in further detail.

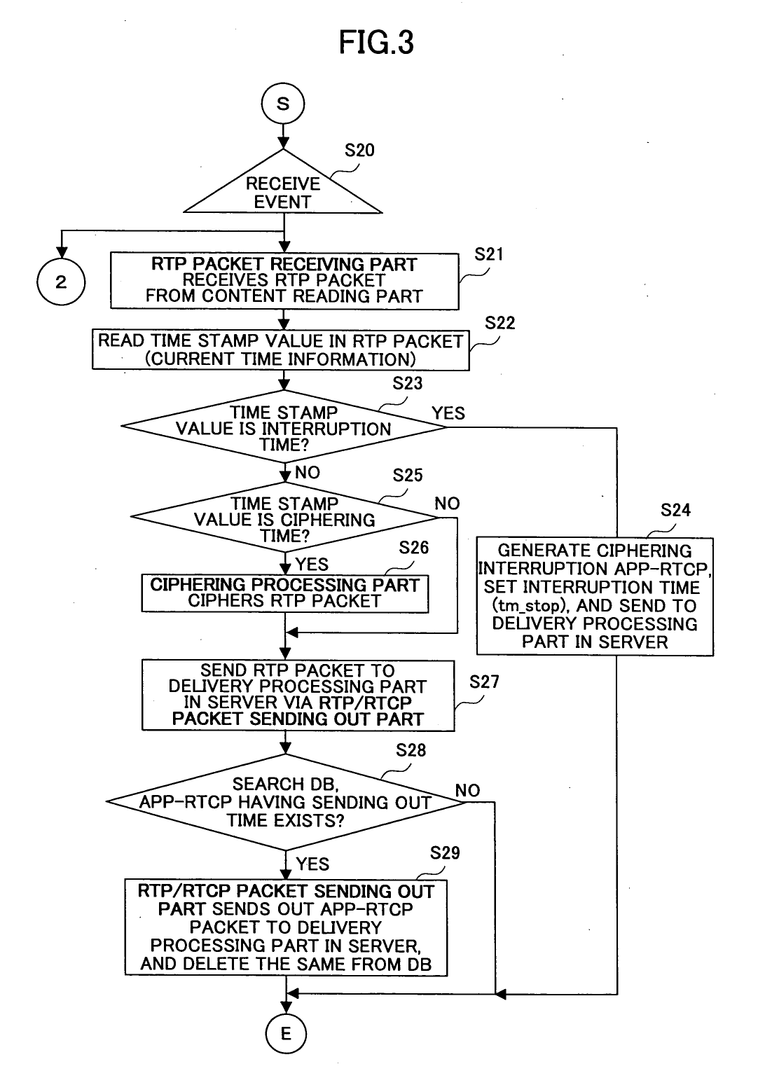

FIG. 3 shows a flow chart of operation performed by the digital content delivery system 100 in response to a predetermined content delivery event given by an external host computer or such not shown.

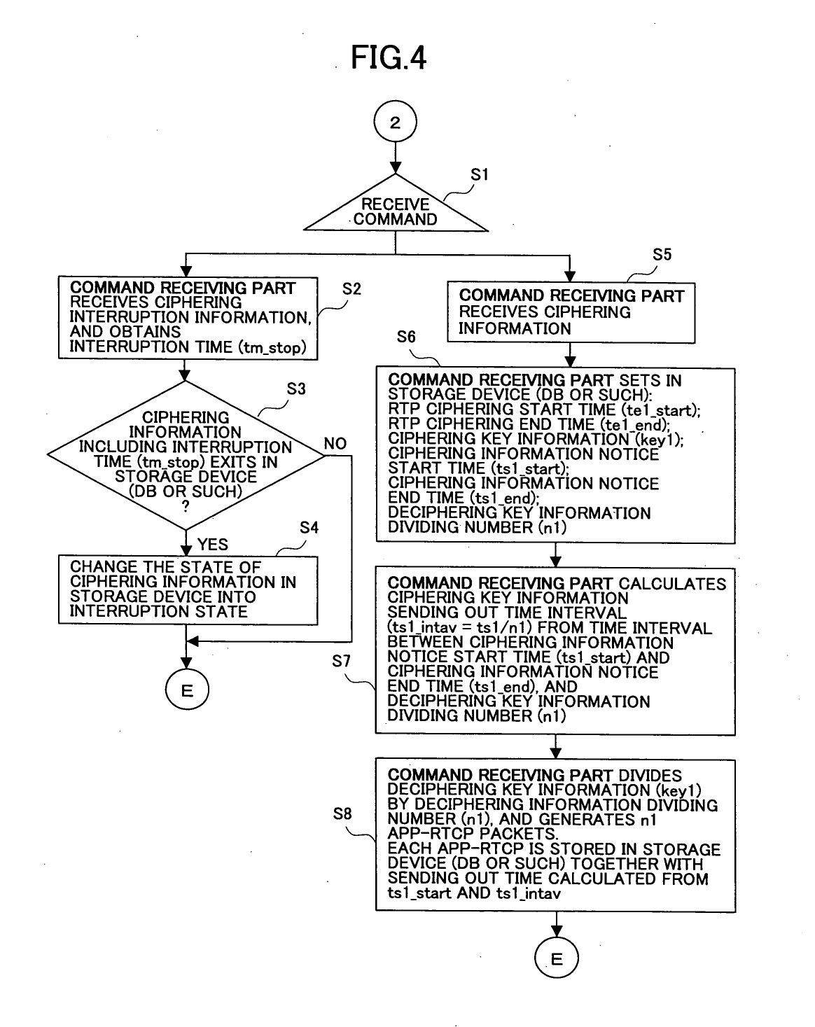

In this case, first, a command included in this event is received by the command receiving part 132 in the digital content ciphering apparatus 130. FIG. 4 shows a flow chart of operation executed by the command receiving part 132 at this time.

With reference to FIG. 4, in Step S2, when a ciphering interruption command externally is received by the command receiving part 132, the command receiving part 132 obtains interruption designated time therefrom. Then, in Step S3, it is determined from time information already set in the storage device 135 whether or not any instructions indicating ciphering for a time interval including the relevant interruption designated time exits there. When the result of the determination indicates that there are no instructions indicating ciphering for a time interval including the relevant interruption designated time (No in Step S3), the current operations is finished. However, when the relevant instructions exists (Yes in Step S3), the relevant instructions are altered with instructions indicating not performing ciphering for a time interval later than the relevant interruption designated time in Step S4.

Further, in Step S5, when the command receiving part 132 receives, as a command, ciphering information indicating instructions concerning ciphering, the command receiving part 132 obtains therefrom RTP ciphering start time, RTP ciphering end time, ciphering key information, ciphering information notice start time, ciphering information notice end time and the number of fragments of ciphering key information to be divided, and writes the respective sorts of information in the storage device 135 in Step S6.

Then, in Step S7, as mentioned above, from a time interval defined between the respective sorts of information, i.e., the ciphering information notice start time and the ciphering information notice end time, and the number of fragments of ciphering key information division, the above-mentioned ciphering key information sending out interval is calculated. Then, in Step S8, the ciphering key information is divided into the above-mentioned number of fragments, the same number of APP-RTCP packets are generated therefor, a sending out time is calculated for each of the thus-divided fragments of the ciphering key information, from the sending out time interval calculated above and the ciphering information notice start time, and the respective APP-RTCP packets are shored in the storage device 135 together with the thus-calculated respective sending out times. Each of the thus-stored APP-RTCP packets will be read out therefrom by the RTP/RTCP packet sending out part 134 when the relevant sending out time is reached, and then, is delivered via the server 120, in Steps S28 and S29 in FIG. 3.

In FIG. 3, the RTP packet receiving part 131 in the ciphering apparatus 130 receives an RTP packet from the content reading part 121 in the digital content delivery server 120 in Step S21, and reads a time stamp value thereof in Step S22. Further, in Step S23, the RTP packet receiving part 131 searches the storage device 135 for ciphering interruption information including the time indicated by this time stamp value in order to determine whether or not this time stamp value is one, for which ciphering is to be interrupted. Then, when the determination result indicates that the time stamp value is one for which ciphering is to be interrupted, the RTP packet receiving part 131 generates an APP-RTCP packet for ciphering interruption instructions in Step S24, and then, transmits it to the delivery processing part 122 in the server 120 after setting therein the relevant interruption designated time (see FIG. 12).

On the other hand, when the time stamp value is different from one for which ciphering is to be interrupted in Step S23, the RTP receiving part 131 searches the storage device 135 for ciphering information including the same time as that indicated by the relevant time stamp value, so as to determine whether or not the relevant time stamp value is one for which ciphering is to be performed, in Step S25. Then, when the determination result indicates that the time stamp value is one for which ciphering is to be performed, in other words, when the relevant time coincides with a time between the ciphering start time and the ciphering end time previously set in the storage device 135 in Step S6, the ciphering processing part 133 ciphers the relevant RTP packet in Step S26. Then, in Step S27, the thus-ciphered RTP packet is sent to the RTP/RTCP packet sending out part 134, and, therethrough, the ciphered RTP packet is sent out to the delivery processing part 122 in the server 120.

Then, in Step S28, the RTP/RTCP packet sending out part 134 searches the storage device 134 so as to determine whether or not the APP-RTCP packet having the sending out time witch coincides with the current time exists there. Then, when the determination results indicates that the relevant APP-RTCP packet exists (Yes in Step S28), the RTP/RTCP packet sending out part 134 reads out the relevant APP-RTCP packet from the storage device 135 in Step S29, and sends it to the delivery processing part 121 in the server 120. Simultaneously, the thus-sent-out packet is deleted from the storage device 135.

FIG. 5 shows a flow chart of operation of the content reading part 121 in the server 120. In the figure, in Step S41, predetermined delivery contents are converted from original medium data into RTP packets as mentioned above. Then, in Step S42, current time information is set in the time stamp part in each of the RTP packet by means of predetermined current time information generating means. Then, in Step S43, it is determined whether or not a current server delivery mode is a ciphering delivery mode. This determination is made by extracting instruction information included in the relevant event received as mentioned above, relevant instruction information having the current time is searched for from the storage device 135, or so.

When the determination result is No (No in Step S43), the relevant RTP packet is sent to the delivery processing part 122 in Step S45. When the determination result is Yes, the RTP packet is sent to the digital content ciphering apparatus 130 in Step S44.

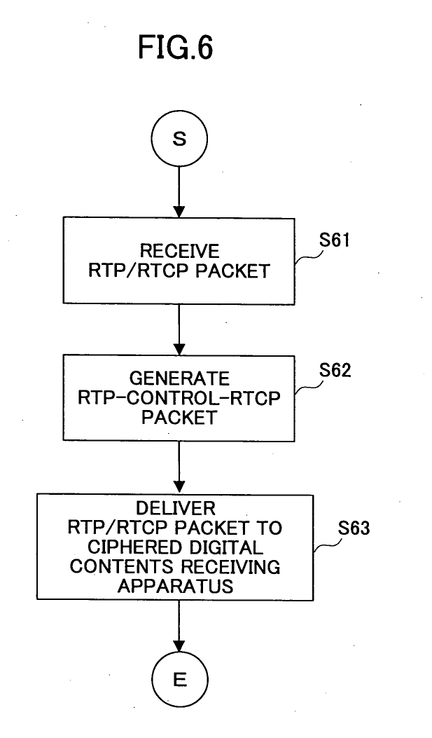

FIG. 6 shows a flow chart of operation of the delivery processing part 122 in the server 120. In the figure, in Step S61, an RTP packet (ciphered or non-ciphered) or an APP-RTCP packet is received from the content reading part 121 or the digital content ciphering apparatus 130. Then, in Step S62, a regular RTCP packet for controlling the RTP packet is generated when the RTP packet is received in Step S61. In Step S63, the RTP packet, the APP-RTCP packet, or the regular RTCP packet mentioned above, is delivered externally (for the ciphered digital content receiving apparatus 200 or such).

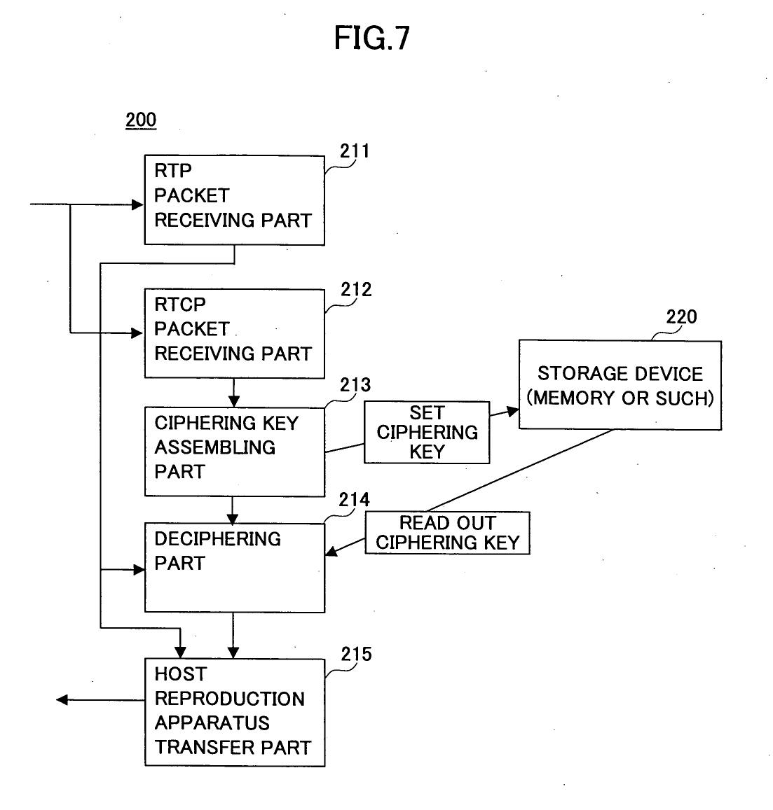

FIG. 7 shows a functional block diagram of the ciphered digital content receiving part 200 which receives the thus-delivered ciphered RTP packet, the non-ciphered RTP packet, or the RTCP packet (the regular one or the APP-RTCP packet provided for the special purpose as mentioned above) and processes it. As shown in the figure, this receiving apparatus 200 includes an RTP packet receiving part 211 receiving the RTP packet, an RTCP packet receiving part 212 receiving the RTCP packet, an ciphering key assembling part 213, a deciphering part 214, a host reproduction apparatus transfer part 215 and a storage device 220.

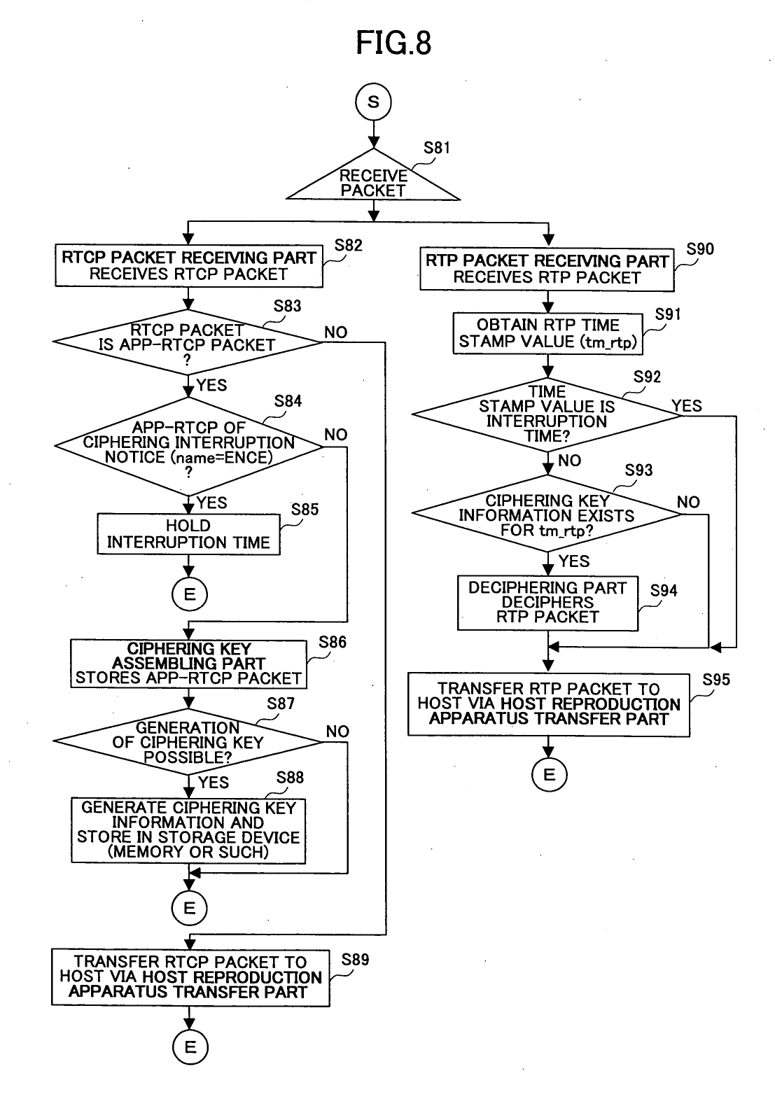

FIG. 8 shows a flow chart of operation performed by this receiving apparatus 200. In this figure, when a packet is received in Step S81, the RTCP packet receiving part 212 receives it in Step S82 if this packet is an RTCP packet. Then, it is determined whether or not the RTCP packet is an APP-RTCP packet in Step S83. When the determination result is No in Step S83, the RTCP packet, i.e., a regular RTCP packet (i.e., a regular RTCP packet used for controlling RTP, other then the above-mentioned APP-RTCP packet carrying the information concerning ciphering) is transferred to the host reproduction apparatus transfer part 215, wherethrough it is sent to a predetermined host reproduction apparatus.

This host reproduction apparatus is a video player, a client computer or such, and thus, is an apparatus for providing relevant contents in a visible and audible form directly to a viewer, i.e., a final user.

When the determination result in Step S83 is Yes, it is determined in Step S84 whether or not the relevant APP-RTCP packet is the APP-RTCP packet for notifying ciphering interruption. Then, when this determination result is Yes, ciphering interruption designated time information indicated by the ciphering interruption information included in the relevant packet is stored in the storage device 220 in Step S85. On other hand, when the determination result in Step S84 is No, it is determined, from a collection of ciphering key information fragments included in the APP-RTCP packets already stored, whether or not predetermined ciphering key information in a complete form can be generated therefrom, in Step S87. When this determination result in Step S87 is No, this means that ciphering key information fragments sufficient to form the complete set of the ciphering key information are not yet accumulated at this time, the relevant operation is finished. When the determination result in Step S87 is Yes, the ciphering key assembling part 213 generates a predetermined ciphering key (substantially serving as deciphering information) from the collection of ciphering key information fragments included in the APP-RTCP packets already stored, and stores it in the storage device 220 in Step S88.

When the received packet in Step S81 is an RTP packet, this packet is received by the RTP packet receiving part 211 in Step S90. Then, in Step S91, a time stamp value thereof is obtained. Then, in Step S92, it is determined whether or not this time stamp value is one for which ciphering is to be interrupted. Specifically, the storage device 220 is searched, and it is determined whether or not a time indicated by the time stamp value is included in the interruption designated time previously stored there. When this determination result in Step S92 is Yes, the relevant RTP packet is transferred to the above-mentioned predetermined host reproduction apparatus via the host reproduction apparatus transfer part 215. In this case, since the time stamp value thus indicates the ciphering interruption mode, it can be determined that the relevant RTP packet is a non-ciphered RTP packet for which the ciphering apparatus 130 in the digital content delivery system 100 did not perform ciphering, according to Step S24 of FIG. 3 described above. Therefore, the RTP packet can be directly transferred to the host reproduction apparatus without a need of deciphering processing.

On the other hand, when the determination result in Step S92 is No, this means that the relevant RTP packet is a ciphered RTP packet, it is determined in Step S93 whether or not ciphering key information, originally used for ciphering in the server's part the contents for a predetermined time interval including the time indicated by the above-mentioned time stamp value, i.e., ciphering key information also used for deciphering the same in the viewer part, exists in the storage device 220. In other words, it is determined whether or not the ciphering key information (in the complete form) is already generated from a collection of fragments in Step S87. When this determination result is Yes, the relevant ciphering key information is used for deciphering the relevant RTP packet by the deciphering part 214, and the thus-obtained result is transferred to the host reproduction apparatus via the host reproduction apparatus transfer part 215 in Step S95.

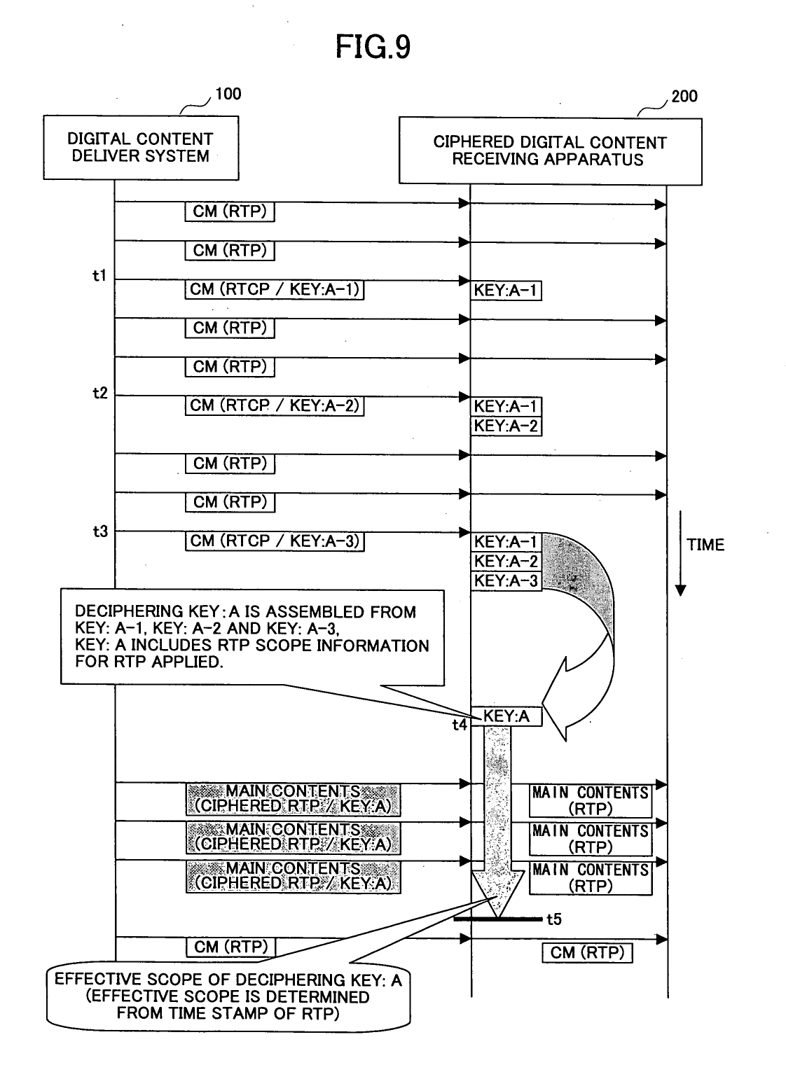

FIG. 9 shows a time chart illustrating a typical example of operation flow according to the embodiment of the present invention in which RTP/RTCP packets are delivered from the digital content delivery system 100 to the ciphered digital content receiving apparatus 200, and are processed by the receiving apparatus 200.

In this figure, until a time t3, RTP packets of CM (commercial message) contents are delivered in prior to delivery of main contents, and, ciphering key information which is originally used for ciphering the main contents and is then needed for deciphering the same in the viewer's part is divided into three fragments KEY:A-1, KEY:A-2 and KEY:A-3, is dispersed in a time-series manner, i.e., at times t1, t2 and t3, respectively, and are delivered during the delivery of the CM contents. As a result, by receiving the CM contents, the ciphered digital content receiving apparatus 200 stores the ciphering key information fragments KEY:A-1, KAY:A-2 and KEY:A-3, which are received, one by one, in sequence, during the reception of the CM contents.

Then, at the time t3, ciphering key information fragments KEY:A-1, KAY:A-2 and KEY:A-3 from which the complete set of the predetermined ciphering key information (i.e., deciphering information) are obtained, and then, the compete set of the predetermined ciphering key information is obtained from combining these fragments at a time t4. After that, thus-obtained ciphering key information, i.e., deciphering information is used for deciphering relevant main contents RTP packets delivered subsequently. A validity due of the ciphering key information KEY:A is previously determined as a time t5, and thus, this key information cannot be used after the time t5. Such a configuration can be achieved as a result of the receiving apparatus 200 comparing the current time and validity due information previously embedded in the ATT-RTCP packet provided for transferring the ciphering key, and determining it invalid when the comparison result indicates that the current time is later than the validity due.

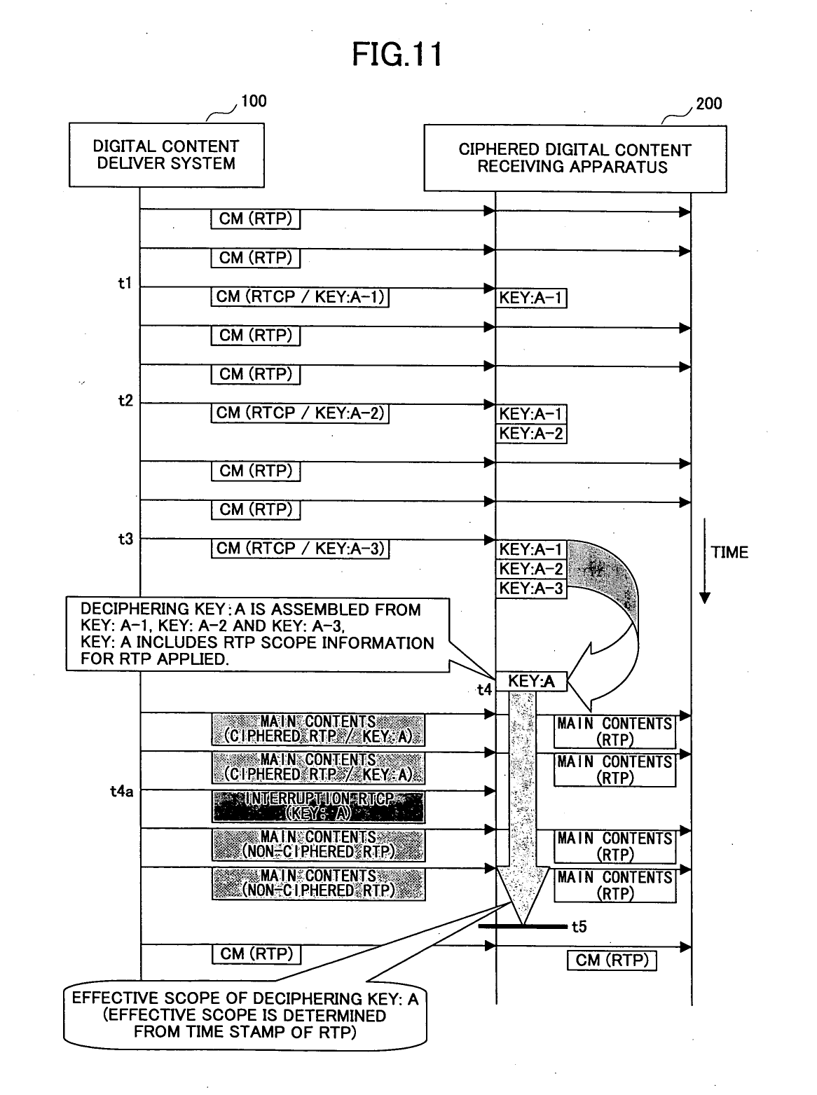

FIG. 11 is same as the time chart shown in FIG. 9, except that, in this case, for example, upon occurrence of an emergency such as a natural disaster, predetermined emergency public contents should be delivered with the use of the digital content delivery system 100 in a hurried manner, and for this purpose, the digital content delivery system 100 sends ciphering interruption instructions to the ciphered digital content receiving apparatus 200. In this case, at a time t4a, earlier than the original ciphering key information validity due, i.e., the time t5, the ciphering interruption instructions indicating a time within the validity period of the ciphering key information KEY:A are given externally to the delivery system 100. In this case, by these ciphering interruption instructions, ciphering is interrupted in the delivery system 100, and thus, non-ciphered contents are delivered therefrom. Accordingly, after the relevant time t4a, received RTP packets can be reproduced in the receiving apparatus 200 without a need to decipher them.

Thus, according to the digital content delivery system according to the embodiment of the present invention, since the payload part of each RTP packet is ciphered one by one in sequence along time axis or temporally, it is possible to achieve a ciphering delivery system flexible not depending from a combination of contents to be delivered, also, it is possible to provide a system thereby, in which, information having mutual relation such as main contents and CM contents, can be viewed by a viewer positively in a manner of having time-series relation therebetween.

The above-described processing of the digital content delivery system 120, the processing of the digital content ciphering apparatus 130 and the processing of the ciphered digital content receiving apparatus 200 can be achieved as a result of preparing programs for causing respective computers to execute instructions included in the programs according to the operations flow charts shown in FIGS. 3, 4, 5, 6 and 8, and causing the computers to execute the processing according to the programs. For this purpose, the thus-prepared programs may be installed in the respective computers as a result of once storing the programs in carriable recording media such as CD-ROMs, loading the recording media to the respective computers and installing the programs in the respective computes from the recording media, respectively, or, as a result of downloading the programs from a server or such via a communication network such as the Internet, and installing the programs in the respective computes. The computers may be those such as personal computers including CPUs, memories such as ROMs, RAMs and so forth, storage devices such as hard disk drives, display devices, man-machine interfaces such as keyboards/mice, also including modems for communications between themselves via a LAN or such and also with a remote server via the Internet. In each computer, the relevant program is first written in the hard disk drive or such, and after that, the program is read out therefrom to be written into the memory, and instructions included therein are executed by the CPU in cooperation with the memories such as RAM and ROM so that the relevant processing shown in the above-mentioned flow charts are performed by the computer.

Further, a field in which the present invention can be applied is not limited to one relating to a relation between CM contents and main contents mentioned above, but an application as described below is also possible:

In an education system with the use of a streaming delivery technique such as an e-learning system or such, the following system may be configured, for example: Deciphering information and relevant ciphered educational material information are repeatedly delivered according to a predetermined order in time-series manner. As a result, if delivered educational materials are viewed by a viewer (student or such) not according to the predetermined order, deciphering thereof cannot be achieved properly, and thus, viewing thereof becomes substantially not possible. Specifically, in this case, during delivery of educational material in a primary stage, deciphering information needed for deciphering educational material in a subsequent stage is transmitted simultaneously, for example. Thereby, viewing from a mid of a course is effectively avoided, and thus, it is possible to effectively avoid the student's incomplete understanding of the educational materials.

Further, the present invention is not limited to the above-described embodiments, and variations and modifications may be made without departing from the basic concept of the present invention claimed.

The present application is based on Japanese priority application No. 2003-424933, filed on Dec. 22, 2003, the entire contents of which are hereby incorporated by reference.

1. An information delivering system for delivering predetermined first information and predetermined second information from a delivering station to a receiving terminal,
wherein the delivering station comprises:
a ciphering part ciphering the second information for each predetermined time interval;
a first information sending out part including deciphering information for the predetermined time interval part of the second information ciphered by said ciphering part in the first information and sending it out; and
second information sending out part sending out the relevant predetermined time interval part of the second information ciphered by said ciphering part after said first information sending out part sends out the first information including the relevant deciphering information, and
wherein after receiving the first information and the second information, the receiving terminal deciphers the predetermined time interval part of the second information with the use of the relevant deciphering information included in the first information, and provides the thus-deciphered information for a user.

2. The information delivering system as claimed in claim 1, wherein:
said delivering station further comprises:
an ciphering interrupting part interrupting ciphering performed by said ciphering part, and
wherein, when ciphering is interrupted by said ciphering interrupting part, said second information sending out part sends out the relevant predetermined time interval part of the second information in a state of not being ciphered.

3. The information delivering system as claimed in claim 1, wherein:
said first information sending out part of said delivering station disperses the deciphering information temporally with respect to the first information when including the deciphering information in the first information and sending it out; and
said receiving terminal collects the deciphering information once dispersed temporally in the first information sent out from said delivering station so as to obtain the original set of the deciphering information, the relevant predetermined time interval part of the first information being able to be deciphered only with the use of the thus-obtained original set of the relevant deciphering information.

4. The information delivering system as claimed in claim 1, wherein:
said second information comprises predetermined digital contents and said first information comprises predetermined advertisement contents.

5. An information delivering apparatus delivering predetermined first information and predetermined second information, comprising:
a ciphering part ciphering the second information for each predetermined time interval;
a first information sending out part including deciphering information for the predetermined time interval part of the second information ciphered by said ciphering part in the first information and sending it out; and
second information sending out part sending out the relevant predetermined time interval part of the second information ciphered by said ciphering part after said first information sending out part sends out the first information including the deciphering information.

6. The information delivering apparatus as claimed in claim 5, further comprising:
an ciphering interrupting part interrupting ciphering performed by said ciphering part, and
wherein, when ciphering is interrupted by said ciphering interrupting part, said second information sending out part sends out the relevant predetermined time interval part of the second information in a state of not being ciphered.

7. The information delivering apparatus as claimed in claim 5, wherein:
said first information sending out part disperses the deciphering information temporally with respect to the first information when including the deciphering information in the first information and sending it out.

8. The information delivering apparatus as claimed in claim 5, wherein:
said second information comprises predetermined digital contents and said first information comprises predetermined advertisement contents.

9. An information delivering method of delivering predetermined first information and predetermined second information from a delivering station to a receiving terminal, comprising the steps of:
a) ciphering the second information for each predetermined time interval in the delivering station;
b) including deciphering information for the predetermined time interval part of the second information ciphered by said ciphering part in the first information and sending it out in the delivering station;
c) sending out from the delivering station the relevant predetermined time interval part of the second information ciphered in said step a) after said the first information including the deciphering information is sent out in said step b), and
wherein after receiving the first information and the second information, the receiving terminal deciphers the predetermined time interval part of the second information with the use of the relevant deciphering information, and provides the thus-deciphered information for a user.

10. The information delivering method as claimed in claim 9, further comprising the step of:
d) interrupting ciphering performed by said ciphering part in the delivering station, and
wherein, when ciphering is interrupted in said step d), the relevant predetermined time interval part of the second information is sent out from the delivering station in a state of not being ciphered.

11. The information delivering method as claimed in claim 9, wherein:
in said step b), the deciphering information is dispersed temporally with respect to the first information when the deciphering information included is sent out included in the first information, and
wherein said receiving terminal collects the deciphering information once dispersed temporally in the first information sent out from said delivering station so as to obtain the original set of the deciphering information, the relevant predetermined time interval part of the first information being able to be deciphered only with the use of the thus-obtained original set of the relevant deciphering information.

12. The information delivering method as claimed in claim 9, wherein:
said second information comprises predetermined digital contents and said first information comprises predetermined advertisement contents.

13. A computer readable information recording medium having a program stored therein, which program causes a computer to deliver predetermined first information and predetermined second information, said program comprising instructions for causing the computer to perform the steps of:
a) ciphering the second information for each predetermined time interval;
b) including deciphering information for the predetermined time interval part of the second information ciphered in said step a) in the first information and sending it out; and
c) sending out the relevant predetermined time interval part of the second information ciphered in said step a) after the first information including the deciphering information is sent out in said step b).

14. The computer readable information recording medium as claimed in claim 13, said program further comprising instructions for causing the computer to perform the step of:
d) interrupting ciphering performed in said step a), and
wherein, when ciphering is interrupted in said step d), the relevant predetermined time interval part of the second information is sent out in said step c) in a state of not being ciphered.

15. The computer readable information recording medium as claimed in claim 13, wherein:
in said step b), the deciphering information is dispersed temporally with respect to the first information when the deciphering information included in the first information is sent out.

16. The computer readable information recording medium as claimed in claim 13, wherein:
said second information comprises predetermined digital contents and said first information comprises predetermined advertisement contents.
